(19) United States
(12) Patent Application Publication
(10) Pub. No.: US 2013/0201892 A1
(43) Pub. Date: Aug. 8, 2013

(54) Discontinuous Reception Across Transmissions on Different Radio Access Technologies

(71) Applicants: Harri Kalevi Holma, Helsinki (FI); Karri Markus Ranta-aho, Espoo (FI); Antti Anton Toskala, Espoo (FI)

(72) Inventors: Harri Kalevi Holma, Helsinki (FI); Karri Markus Ranta-aho, Espoo (FI); Antti Anton Toskala, Espoo (FI)

(73) Assignee: Nokia Siemens Networks Oy, Espoo (FI)

(21) Appl. No.: 13/825,132

(22) PCT Filed: Jul. 26, 2011
(86) PCT No.: PCT/EP2011/062814

§ 371 Date: Apr. 15, 2013

Related U.S. Application Data
(60) Provisional application No. 61/384,515, filed on Sep. 20, 2010.

(51) Int. Cl. H04W 76/04

(52) U.S. Cl. CPC H04W 76/048
USPC 370/311

(57) ABSTRACT

In an embodiment there is established for a user equipment UE a first discontinuous reception DRX period of a first radio access technology RAT using at least one parameter that is common with a second DRX period of a second RAT for the UE. From the perspective of the network, transmission opportunities to the UE using the first RAT are arranged according to the established first DRX period. From the perspective of the UE, reception opportunities at the UE using the first radio access technology are arranged according to the established first DRX period. There may be one access node or two cooperating access nodes serving the UE with the different RATs. In different embodiments the DRX active periods may be purposefully aligned or misaligned. Examples of such a common DRX parameter include DRX cycle, DRX inactivity timer, and DRX on-duration time.

### TECHNICAL FIELD

The exemplary and non-limiting embodiments of this invention relate generally to wireless communication systems, methods, devices and computer programs and, more specifically, relate to discontinuous reception for user equipments operating simultaneously in two different radio technology systems.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
ACK/NACK acknowledgement/negative acknowledgement
CA carrier aggregation
CC component carrier
CQI channel quality indicator
DL downlink (eNodeB or base station to UE direction)
DRX discontinuous reception
DTX discontinuous transmission
E-UTRAN evolved universal terrestrial radio access network
F-DPCH fractional dedicated physical channel
HSDPA high speed downlink packet access
HSPA high speed packet access
LTE long term evolution (also termed E-UTRAN)
MAC medium access control
PDCP packet data convergence protocol
PDCCH physical downlink control channel
PDSCH physical downlink shared channel
PUSCH physical uplink shared channel
RAN radio access network
RAT radio access technology
RF radio frequency
RLC radio link control
UE user equipment
UL uplink (UE to eNodeB direction)

The DRX concept is well known in the cellular radio arts, and broadly illustrated for the LTE system at FIG. 1. There are DRX periods during which a mobile terminal/UE is allowed to power down (sleep or idle mode) to conserve power and during which the network refrains from sending transmissions directed to that UE. Other active periods are synchronized to this DRX period. The PDCCH gives resource allocations to multiple mobile terminals for resources in the UL and DL shared channels, shown as PDSCH and PUSCH. More than one consecutive PDCCH may be used (the duty cycle or ‘on-duration’), but the overall schedule repeats after each DRX.

The UEs synchronize to the PDSCH and align to the RRC-Connected/idle mode DRX of the eNodeB (a base station in an LTE RAN) in order to receive possible resource allocations/paging messages from network. One of the parameters needed in RRC-Connected/idle mode terminal is the RRC-Connected/idle mode DRX period so that UE and eNodeB have a synchronized resource allocation/paging occasions defined by the DRX schedule during which the eNodeB can send resource allocations or a page to the UE, which tunes to listen at those times.

Many other RATs use a DRX period to allow the UE to conserve its battery power though they may schedule UEs differently than the PDCCH/PUSCH concept in LTE. For example, the GERAN system uses a paging period, legacy UTRAN (3G) uses paging and idle mode DRX and UTRAN HSPA uses a connected mode DRX cycle.

The concept of carrier aggregation CA is also well known in the cellular radio arts, an example for the LTE system being illustrated at FIG. 2. Release 10 of LTE (LTE-Advanced) is to implement bandwidth extensions beyond 20 MHz via CA in which several CCs, at least one of which is backwards (Release 8) compatible, are aggregated together to form a wider system bandwidth than a single component carrier alone is providing. The example at FIG. 2 illustrates five 20 MHz CCs aggregated to form one larger LTE-Advanced bandwidth of 100 MHz. LTE-A terminals are intended to receive/transmit on multiple CCs at the same time to give the eNodeB greater scheduling flexibility while increasing data throughput. Other CA implementations need not have identical bandwidths in the CCs; and/or the CCs may not be contiguous in frequency; and/or the total CA bandwidth may be more or less than 100 MHz; and/or there may be an asymmetric DL/UL CA which by example may include a frequency division duplex CC combined with a time division duplex CC.

Increasingly, UE's are capable of transmitting and receiving in multiple RATs, simultaneously in the case of the UE having multiple radios or nearly so in the case of the UE re-tuning its cellular radio for the different-RAT channels according to the different-RAT schedules. The inventors have recognized that where the DRX periods of the different RATs are not aligned for a UE configured to be able to receive data transmissions from more than one RAT simultaneously, there is a potential waste of battery power at the UE since it cannot power down to its full extent so long as the UE remains active for one of the RATs.

### SUMMARY

In a first aspect thereof the exemplary embodiments of this invention provide a method comprising: establishing for a user equipment a first discontinuous reception period of a first radio access technology using at least one parameter that is common with a second discontinuous reception period of a second radio access technology for the user equipment; and arranging at least one of transmission opportunities to the user equipment using the first radio access technology or reception opportunities at the user equipment using the first radio access technology, according to the established first discontinuous reception period.

In a second aspect thereof the exemplary embodiments of this invention provide a computer readable memory storing a program of instructions which when executed by at least one processor result in actions comprising: establishing for a user equipment a first discontinuous reception period of a first radio access technology using at least one parameter that is common with a second discontinuous reception period of a second radio access technology for the user equipment; and arranging at least one of transmission opportunities to the user equipment using the first radio access technology or reception opportunities at the user equipment using the first radio access technology, according to the established first discontinuous reception period.

In a third aspect thereof the exemplary embodiments of this invention provide an apparatus comprising at least one processor and at least one memory storing computer readable instructions. In this aspect the at least one memory with the computer readable instructions is configured with the at least one processor to cause the apparatus at least to perform: establishing for a user equipment a first discontinuous reception period of a first radio access technology using at least one parameter that is common with a second discontinuous reception period of a second radio access technology for the user equipment; and arranging at least one of transmission opportunities to the user equipment using the first radio access technology or reception opportunities at the user equipment using the first radio access technology, according to the established first discontinuous reception period.

### BRIEF DESCRIPTION OF THE DRAWINGS

FIG. 1 is a prior art block diagram of a channel structure showing a DRX period for a single mobile terminal in E-UTRAN Release 8.

FIG. 2 is a schematic frequency diagram of a radio spectrum characterized by carrier aggregation, in which five component carrier bandwidths are aggregated into a single LTE-A bandwidth.

FIG. 3 is a schematic block diagram of a base station and a user equipment employing aggregated radio access technologies LTE and HSDPA in the downlink according to an exemplary embodiment of the invention.

FIG. 4 is a schematic block diagram showing protocol layer stacks in the base station and user equipment of FIG. 3, according to an exemplary embodiment of the invention.

FIG. 5 is a timing diagram showing radio scheduling in two radio access technologies (RATs), such as LTE and HSDPA, in which there is a common DRX period that is time aligned between the two radio access technologies according to an exemplary embodiment of the invention.

FIG. 6 is similar to FIG. 5 but in which the common DRX period is not time aligned between the two radio access technologies.

FIG. 7 is similar to FIG. 5 but showing the specific case in which transmissions can continue in only one of the radio access technologies.

FIG. 8 is a simplified block diagram of certain apparatus for practicing certain exemplary embodiments of the invention.

FIG. 9 is a logic flow diagram that illustrates the operation of a method, and a result of execution of computer program instructions embodied on a computer readable memory, in accordance with the exemplary embodiments of this invention.

### DETAILED DESCRIPTION

Inter-RAT carrier aggregation is one potential technique for boosting data rates and system throughput, where one UE can receive (or even transmit) data from two different RATs, by example LTE and HSPA. Exemplary embodiments of the invention facilitate power savings at the UE by means of adapting the discontinuous reception periods of the two RATs during data inactivity (e.g. when there is no data for the network to transmit to the UE), while still enabling the UE to receive data from both RATs during data activity. The exemplary embodiments described herein are in the context of LTE and HSPA as the two RATs for clarity of explanation and not by way of limitation. These teachings may be readily adapted for other pairs of RATs, and may be readily extended across more than two RATs.

While the assumption in at least LTE-Advanced is that the LTE CCs will have identical timing and DRX/DTX parameters, for the case of multi-RAT capable UEs the common understanding is that the DRX/DTX periods and parameters are independent across the different RATs. This follows from the fact that in each RAT the DRX/DTX timing arises from the frame timing, and there is no slaving of transmission frames of one RAT to frame timing in another RAT.

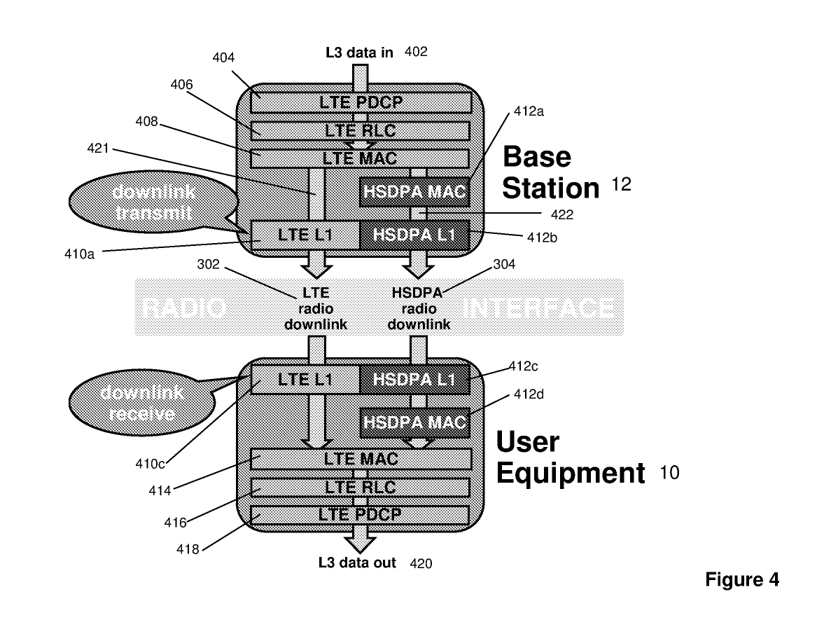

FIG. 3 illustrates schematically an access node/base station (eNode B or eNB) 12 transmitting a DL LTE radio transmission 302 and also simultaneously a DL HSPA transmission 304 to a UE 10. FIGS. 3-4 illustrate using a single eNB/base station 12 for simplicity but similar results can be attained with two cooperating access nodes separately transmitting the different RAT transmissions 302, 304 using the common DRX concepts which are detailed further below. The LTE-Advanced version of LTE as well as the multicarrier version of HSPA each use some version of CA, and so the common DRX concepts detailed below may be applied for a CA on one RAT and a CA on another RAT, or multiple CAs on one or both of them.

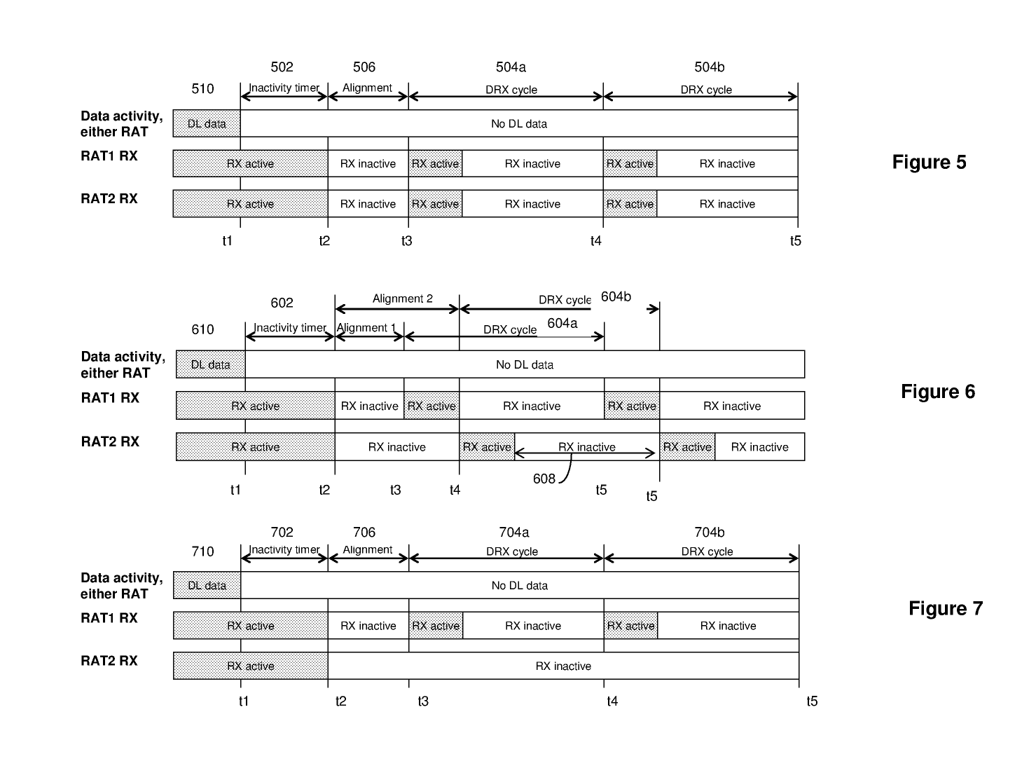

In current practice these RATs run their DRX functions independently of one another, regardless of whether the LTE and HSPA transmissions come from one access node or different nodes. As noted above it cannot be assumed that both LTE transmissions 302 and HSPA transmissions 304 would be fully synchronized in terms of frame synchronization. When an individual UE is using both systems simultaneously such as to increase its DL data rate, the DRX-related power savings at the UE may be quite diminished as compared to if the UE were only operating on one RAT, or as compared to the power savings resulting from these teachings in which the DRX state machines are not fully independent across different RATs. In addition to worse power saving performance, with fully independent DRX functionalities, if the base station has data to transmit that it splits between LTE and HSPA it would need to wake up both LTE and HSPA radios separately. One technical effect of the exemplary embodiments detailed with reference to FIGS. 5-7 below is that the base station can wake up both radios at the UE by sending traffic over whichever radio is available first. Another disadvantage of fully independent DRX functionalities is that it is impossible to completely shut down one of the two RATs as each one would have to independently awakened to monitor possible new data traffic to it, a problem which the example at FIG. 7 fully solves. FIGS. 5-7 below are in the context of the different RAT frames being synchronized for clarity of explanation, but certain exemplary embodiments of this invention also operate when there is frame mis-alignment as between the RATs.

FIG. 4 illustrates an exemplary arrangement of protocol stacks in the access node 12 and the UE 10 of FIG. 3 enabling simultaneous transmission of data over both LTE and HSDPA radios. Layer 3 data 402 for transmission on the DL to the UE 10 passes through the access node's 12 LTE PDCP layer 404, LTE RLC layer 406 and LTE MAC layer 408 in order, where the data is split into two streams 421, 422. The LTE stream 421 passes through the LTE layer 1 410b and is then transmitted on the LTE radio DL 302. The HSPA stream 422 passes through the HSDPA MAC layer 412a and HSDPA layer 1 412b in order after which the user data is transmitted on the HSDPA radio DL 304. For the case in which there are two cooperating access nodes as noted above, the LTE DL 302 is sent from a LTE access node which has the LTE layer 1 410b, and the HSDPA transmission 304 is sent from a cooperating HSPA access node which has the HDPA MAC layer 412a and the HSDPA layer 1 412b.

The UE 10 receives and processes these two streams as follows. The LTE DL transmission 302 is received and passes through a LTE layer 1 410c, a LTE MAC layer 414, a LTE RLC layer 416 and a LTE PDCP layer 418 in order, and the data is subsequently output as layer 3 user data 420. The HSDPA transmission 304 is received and passes through a HSDPA layer 1 412c, and a HSDPA MAC layer 412d in order, followed by the LTE MAC layer 414, the LTE RLC layer 416 and the LTE PDCP layer 418 in order. That HSDPA data is also subsequently output as layer 3 user data 420. The two received data streams are combined in the MAC layer 414 so that the output layer 3 user data 420 is re-combined to match the user data that was input as layer 3 data 402 prior to being split at the MAC layer 408 of the access node 12.

According to an exemplary embodiment of the invention there is an interlinking of DRX periods of a first RAT and of a second RAT. For example, the DRX operation of one RAT is dependent on data which is received at the UE (or sent to the UE by the access node) on any one of the multiple RATs.

More particularly, in an exemplary embodiment there is established for a UE a first DRX period of a first RAT using at least one parameter that is common with a second DRX period of a second RAT for the UE. Consequently, transmissions to the user equipment using the first RAT or receptions at the user equipment using the first RAT are arranged according to the established first DRX period.

Stating these embodiments in this manner reads on any of three parties which might be involved in the transmissions: the UE itself which receives them; the access node which sends transmissions to the UE simultaneously using the first RAT and using the second RAT; and a first access node which sends transmissions to the UE using the first RAT and which establishes the first DRX period by coordinating the at least one common DRX parameter with a second access node which sends transmissions to the UE using the second RAT simultaneously with the transmissions sent from the first access node.

Embodiments of the invention may therefore be practiced in both the UE and in the access node because both entities need to track the UE's DRX periods; the UE to assure it operates at reduced power only while the DRX period is in effect and the access node(s) to assure they transmit to the UE only when the UE is not in its DRX period. In more specific embodiments the first DRX period is within a CC of the first RAT (e.g., LTE), and the second DRX period is within a CC of the second RAT (e.g., HSPA).

FIGS. 5-7 depict timing diagrams showing DL data activity on the top row, and receive-active periods (labelled RX active) and DRX periods (labelled RX-inactive) for the first and second RATs on the respective second and third rows. Each of those second and third rows may be a specific CC on the respective RAT. Those figures illustrate the DRX operation starting after there is a specific period of downlink data inactivity at both RAT CAs. The actual timing of a DRX cycle's active period and DRX period are independent of the data activity, which is why there is a ‘nominal’ alignment period shown which indicates a receive-inactivity period starting in the middle of a DRX cycle due to data inactivity. In an embodiment the alignment of the start of the DRX cycle is derived from the actual DRX cycle offset and the cell timing rather than from the actual time instant when the DL data transmission stopped. Since the purposeful alignment (or misalignment) of the DRX periods detailed herein are not in all embodiments dependent on actual data being transmitted to the UE, the receive-active periods may be considered more broadly to be transmission opportunities by which the access node(s) may send data to the UE if it has data to send. From the UE's perspective these same receive-active periods are reception opportunities.

Exemplary embodiments of the common DRX parameter include a DRX cycle, a DRX inactivity timer, and a DRX on-duration time. In some embodiments there may be more than only one DRX parameter in common.

The common DRX parameter enables timing of the active and inactive reception phases to be aligned so that when the DRX is operating the active reception phases of the two radios are aligned as shown at FIG. 5. At FIG. 5 there are two common parameters: DRX inactivity timer 502 and DRX cycle 504a/b. The access node transmits data 510 to the UE on RAT1, at a time during which the UE is RX-active for both RAT1 and RAT2. Data transmission terminates at time t1, and so the UE initiates its DRX inactivity timer 502. When the timer 502 expires at time t2 and the UE has not received any further data on either RAT, the UE sets the DRX mode for both RAT1 and RAT2. At time t3 the normal DRX cycle 504a begins for the UE on RAT1. In this example the UE aligns its DRX cycle for RAT2 to the normal DRX cycle 504a for RAT1, and the DRX cycles will remain aligned until there is DL data on one RAT but not the other, after which the alignment period 506 will be employed after the inactivity timer 502 to re-align the DRX cycles 504a/b. In the normal DRX cycle 504a for RAT1 the UE is RX-active for an initial period and if there is no DL activity the UE enters the RX-inactive state and operates in a reduced power state (idle mode or similar) until the end of the DRX cycle 504a at time t4 at which the UE begins a new DRX cycle 504b with a new RX-active state followed by a RX-inactive state until time t5 if there is no DL data. The DRX cycle for RAT2 is the same as that for RAT1 since the DRX cycles 504a/b themselves are common. When the DRX cycles are aligned, the DRX cycle of one RAT is repeated on the other RAT, including RX-active and RX-inactive periods which fully align as shown.

Alternative to full DRX alignment at FIG. 5, the timing of the phases can be aligned so that the active reception phases of the two radios are misaligned when the DRX is operating. This is shown at FIG. 6 which employs also two common parameters, but this time they are DRX inactivity timer 602 and DRX on-duration 608. Like FIG. 5 assume that these parameters are from RAT1 and copied to mis-align the active reception phase RX-active of RAT2 as compared to that of RAT1. Like FIG. 5, the access node in FIG. 6 transmits data 610 to the UE on RAT1 at a time during which the UE is RX-active for both RAT1 and RAT2. Data transmission terminates at time t1, and so the UE initiates its DRX inactivity timer 602 which expires at time t2 with the UE not receiving any further data on either RAT. Notice that the DRX cycle 604a for RAT1 which runs between times t3 and t5 has the same arrangement of RX-active and RX-inactive as the DRX cycle 604b for RAT2 which runs between times t4 and t6. During the RAT1 alignment period (alignment1) between times t2 and t3 the UE is simply remaining RX-inactive until the onset of its next RAT1 DRX cycle 604a at time t3. During the RAT2 alignment period (alignment2) between times t2 and t4 the UE is simply remaining RX-inactive until the onset of its next RAT2 DRX cycle 604b at time t4.

Time t4 is the end of that RX active period, and so assuming there is no DL data for the UE on RAT1 the UE switches to RX-inactive according to the RAT1 DRX cycle 604a which it has already started at time t3. The span between times t3 and t4 is the length of the RX-active period of the RAT1 DRX cycle 604a, and so also at time t4 when the UE goes to RX-inactive on RAT1 the UE begins its new DRX cycle 604b for RAT2 and goes RX-active on RAT2. In an embodiment this mode switch on RAT2 is regardless of any DL data incoming on RAT1 between times t3 and t4. The RX-active modes for the different RATs in FIG. 6 remain mis-aligned because the DRX on-duration 608 from RAT1 is repeated for RAT2, meaning the onset of the next RAT1 DRX cycle at time t5 remains mis-aligned with the onset of the next RAT2 DRX cycle at time t6. The equivalent result can be achieved if the DRX on-duration were instead defined as the RX-active period.

The difference between FIGS. 5 and 6 depends on what is targeted. For example, if the two RATs operate on the same frequency band it may be beneficial to deactivate both RATs at the same time as in FIG. 5 in order to enable the RF front end at the UE to be disabled. Similarly if the RATs operate on different bands it may be beneficial to misalign the active phases as in FIG. 6 in order to keep only one UE receiver active at any one time to reduce peak receive power consumption and to have a larger overall receiver on-off ratio at the UE. This larger overall on-off ratio over the two different radios going active allows for a faster resumption of data transmission. These teachings therefore encompass deliberately being able to configure the receive-active phases of the DRX cycles to be either aligned across the RATs as in FIG. 5 or misaligned across the RATs as in FIG. 6, each embodiment exhibiting different advantages which are relevant to different use cases.

In a basic conventional DRX operation, if there is no activity on downlink for a given time duration, then the UE starts monitoring the downlink only on predetermined downlink sub-frames. According to an exemplary embodiment of this invention, the data transmitted on a first RAT can reset the timer counting the DL inactivity on both RATs. This technique may or may not be reciprocal in different embodiments. In one embodiment in which the operation is not reciprocal, when there is data sent on the second RAT that data may reset the inactivity timer only for the second RAT. In another embodiment in which the operation is reciprocal, when there is data sent on the second RAT that data may reset the inactivity timer both RATs.

Additionally, in an embodiment shown by example at FIG. 7, one or the other RAT could be completely disabled and the UE's periodic monitoring of the downlink transmissions (and the access node's schedule for when it may transmit to that UE) could only take place on the other RAT. The complete disabling of one of the RAT RX-radios could in an embodiment be conditional to the data activity on either of the RATs, on that RAT only, and/or the channel conditions (for example, CQI) on that RAT. Notably only one of the two RATs would be allowed to be completely disabled in this embodiment as otherwise resumption of transmission would not be at all possible. It is anticipated that it is more advantageous to fully disable the RAT which is expected to have worse coverage in a particular deployment scenario.

At FIG. 7 the initial condition is similar to that at FIGS. 5-6: the access node sends data 710 to the UE on RAT1 at a time during which the UE is RX-active for both RAT1 and RAT2. Data transmission terminates at time t1, the UE initiates its DRX inactivity timer 602 which expires at time t2 with no further data received at the UE on either RAT. During the alignment period 706 the UE remains RX-inactive on RAT1 to align to its normal RAT1 DRX cycle 704a which begins at time t3. That normal DRX cycle 704a for RAT1 in FIG. 7 is similar to those in FIGS. 5-6; a RX-active period followed by a RX-inactive period until time t4 if no DL data is received to extend beyond the RX-active period. The next RAT1 DRX cycle 704b follows normally at time t4. But once the inactivity timer 702 expires, the RAT2 RX-radio remains in a DRX-inactive mode indefinitely. It is completely disabled for this UE. In one embodiment the UE switches its RAT2 radio to a RX-active mode only upon explicit signalling on RAT1 from the access node. That signaling may in one embodiment be control signaling, or in another embodiment it may be any user data so that any DL data the UE receives on RAT1 is cause to automatically switch the RAT2 radio to RX-active. In the FIG. 7 embodiment the sole DRX parameter that is common is the inactivity timer 702; once the timer expires at time t2 the RAT2 radio remains RX-inactive until some activity on RAT1, meaning the DRX cycle on RAT2 depends wholly on RX-activity on RAT1.

When new data arrives and is received by the UE during the RX-active phase of a DRX cycle, the DRX mode is suspended and the UE resumes continuous monitoring of the downlink. The continuous monitoring of both RATs could in an embodiment resume automatically when data arrives over any one of the RATs.

As a variation to the FIG. 7 example, the UE stops completely receiving RAT2 when RAT1 has entered DRX at time t2. In order to provide maximum UE power savings while enabling peak data rates when needed, when there is data again on RAT1 such as at time t4 the UE automatically synchronizes with RAT2 and again starts data reception on RAT2 as well as on RAT1. The UE can indicate its readiness to receive on RAT2 by reporting CQI for example to the access node handling its RAT2 data. The automatic waking of the RAT2 radio could be conditional on any data (e.g., one packet) being received on the RAT1 radio, or on some threshold volume of data being received there. Once the RAT2 radio was RX-active again the UE could resume sending normal periodic RAT2 CQI reports. The access node could then determine from the CQI reports and the volume of data it has for the UE whether to send the data to the UE only on one RAT (e.g., LTE) or to split the data and send it on both RATs.

The above DRX parameters are already known in various radio technologies, but the concepts presented herein are not limited to only those known DRX parameters. New DRX parameters may be defined to give a more flexible approach to aligning/misaligning the RX-active periods of different RAT CAs for a same UE, or to enable more efficient signaling between network and UE for how to implement a specific embodiment of these teachings. Some such parameters would indicate one or more of the following:
data inactivity duration before DRX is activated (either common or RAT-specific)
DRX cycle duration (either common or RAT-specific)
DRX cycle offset (either common or RAT-specific)
   RAT specific cycle offset, which allows the network to decide if the RX-active phases are aligned or non-aligned
presence of DRX on phases during DRX cycle (complete disabling of a RAT)
CQI thresholds (how long the CQI needs to be at or below a specific threshold before a RAT is to be completely deactivated)
reactivation parameters (indicating whether data on RAT1 is to activate RAT2 and vice versa, what amount of data traffic is needed on RAT1 before RAT2 is also activated, whether some explicit signaling is needed for reactivating one or the other RAT)

In case there is a timing uncertainty between the first and second RATs, the UE can provide a measurement of the relative timing difference between the RATs to enable setting the proper timing for discontinuous transmission or reception. Such a measurement could be based on the timing difference between the component carriers. Alternatively, the UE could report or otherwise suggest, upon reception of the parameters for one radio access technology, which would be the preferred parameterization for the second radio access technology. These timing issues are more likely for the case in which there are two distinct access nodes each serving the same UE using a different RAT and coordinating among the access nodes the value for one or more of the DRX parameters that is to be in common among the RATs for that UE.

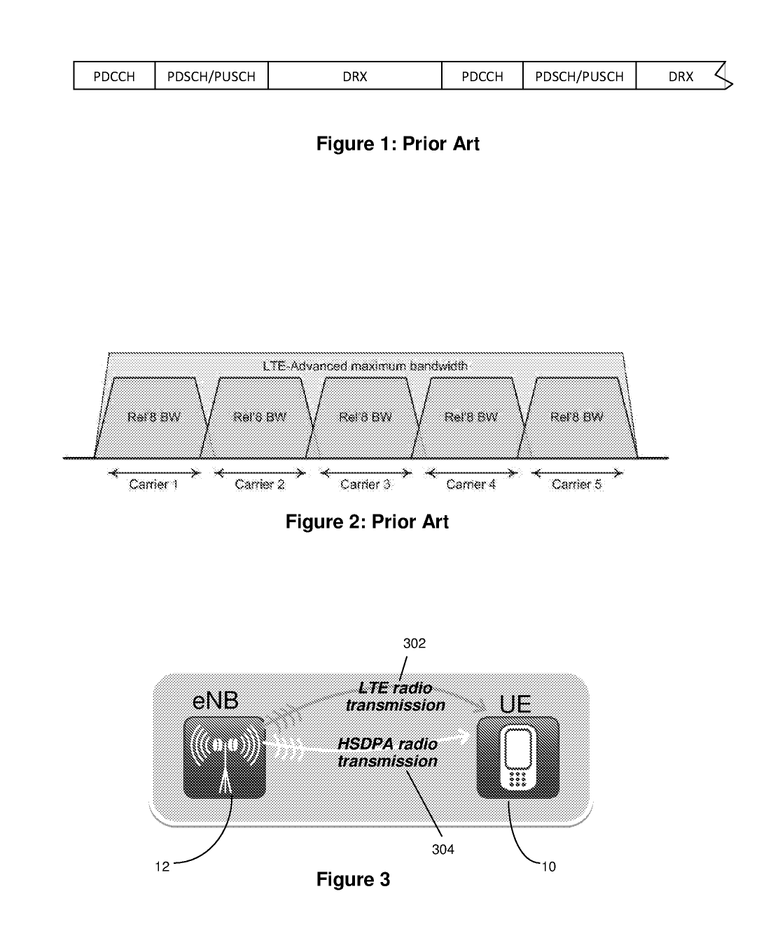

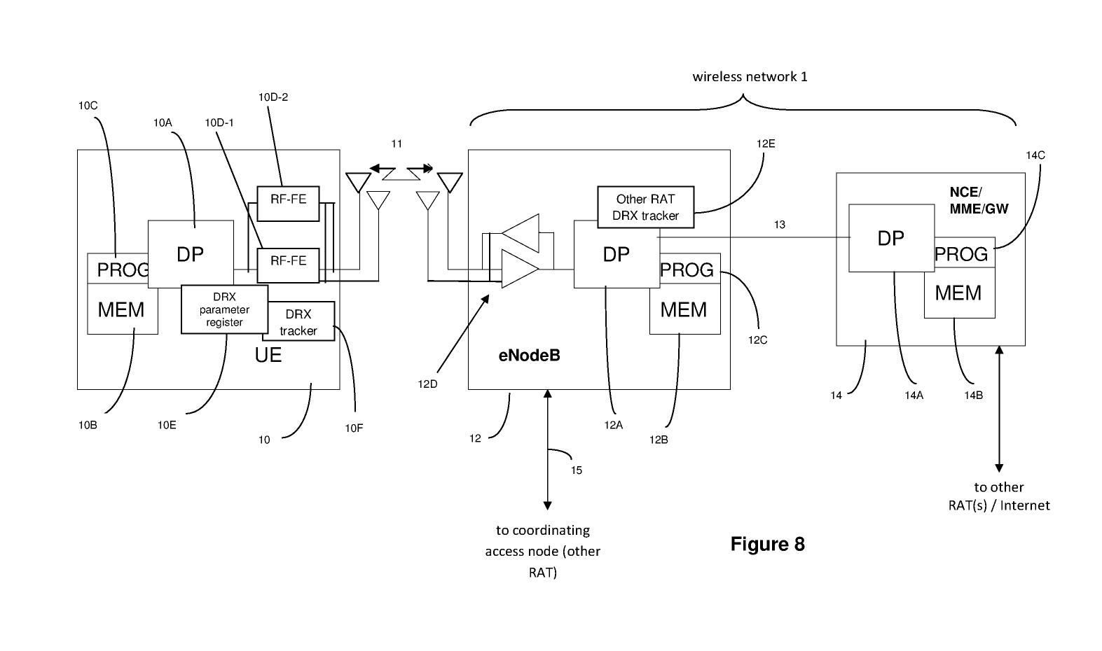

FIG. 8 is a simplified block diagram of various electronic devices and apparatus that are suitable for use in practicing the exemplary embodiments of this invention. In FIG. 8 a wireless network 1 is adapted for communication over a wireless link 11 with an apparatus, such as a mobile communication device which above is referred to as a UE 10, via a network access node, such as a Node B (base station), and more specifically an eNodeB 12. The network 1 may include a network control element (NCE) 14 that may include the mobility entity/serving gateway MME/S-GW functionality shown in FIG. 1, and which provides connectivity with a network, such as a telephone network and/or a data communications network (e.g., the internet).

The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transceiver for bidirectional wireless communications with the eNodeB 12 via one or more antennas. At FIG. 8 there is shown two separate RF front ends (RF-FE) 10D-1 and 10D-2, indicating this particular UE 10 is capable of handling two separate DRXs on two different RATs. Of course other UEs can have different RF layouts. The eNodeB 12 also includes a controller, such as a computer or a data processor (DP) 12A, a computer-readable memory medium embodied as a memory (MEM) 12B that stores a program of computer instructions (PROG) 12C, and a suitable RF transceiver 12D for communication with the UE 10 via one or more antennas. The eNodeB 12 is coupled via a data/control path 13 to the NCE 14, such as for example an 51 interface. For embodiments in which there are two access nodes, each transmitting using a different RAT, there is a second access node similar to the one shown at FIG. 8 and they cooperate across the data/control path 15 to find a common DRX parameter. Alternatively, the cooperation may be among higher nodes in the network using the link shown from the NCE 14 to other RAT networks.

At least one of the PROGs 10C and 12C is assumed to include program instructions that, when executed by the associated DP, enable the device to operate in accordance with the exemplary embodiments of this invention. That is, the exemplary embodiments of this invention may be implemented at least in part by computer software executable by the DP 10A of the UE 10 and/or by the DP 12A of the eNodeB 12, or by hardware, or by a combination of software and hardware (and firmware).

For the purposes of describing the exemplary embodiments of this invention the UE 10 may be assumed to also include a DRX parameter register 10E which stores the DRX parameters which the UE uses to find the RX-active and RX-inactive periods detailed by example above. The UE is also assumed to include a DRX per RAT tracker 10F which tracks which DRX pattern it is to apply to each of its configured CCs on the different RATs. The eNodeB 12 is also assumed to include a DRX per CC tracker 12E which tracks similarly on a per UE basis, and the eNodeB stores the DRX parameters for a given UE in its MEM 12B. While these elements 10E, 10F, 12E are shown at FIG. 8 as being separate from the DPs 10A, 12A, in various implementations their function may be embodied by a stand-alone processor or chip or memory and in another implementation the function of those elements 10E, 10F, 12E is incorporated into the main processor 10A, 12A. When implemented in a memory, the MEM 10B, 12B illustrated are representative of any computer readable memory and not necessarily only one memory element; such a memory implementation may be on-chip with a processor or stand-alone with a bus connection to the relevant processor.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multicore processor architecture, as non-limiting examples.

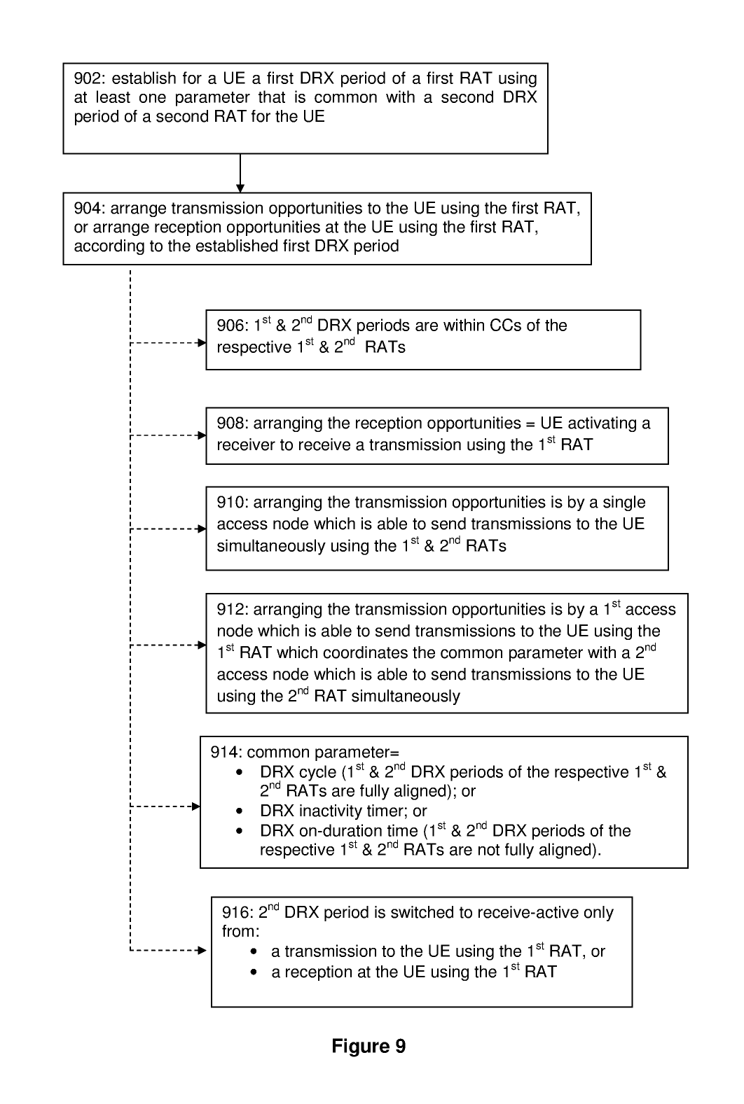

FIG. 9 may be considered to be a logic flow diagram that illustrates the operation of a method, and the result of execution of computer program instructions, in accordance with the exemplary embodiments of this invention. Dashed lines at FIG. 9 indicate optional elements. The various blocks shown in FIG. 9 may be viewed as method steps, and/or as operations that result from operation of computer program code, and/or as a plurality of coupled logic circuit elements constructed to carry out the associated function(s).

For example, the UE and eNodeB, or one or more components thereof, can be described as an apparatus comprising at least one processor and at least one memory including computer program code, in which the at least one memory and the computer program code are configured to, with the at least one processor, cause the apparatus to perform the elements shown at FIG. 9 and/or recited in further detail above.

In accordance with the exemplary embodiments at block 902 there is established for a UE a first DRX period of a first RAT using at least one parameter that is common with a second DRX period of a second RAT for the UE. At block 904 transmission opportunities to the user equipment using the first radio access technology are arranged (from the access node's perspective) or reception opportunities at the user equipment using the first radio access technology are arranged (from the UE's perspective), according to the established first DRX reception period.

Further elements at FIG. 9 describe certain of the exemplary embodiments detailed above, and may be employed with blocks 902 and 904 individually or in various combinations. At block 906 the first and second DRX periods are within CCs of the respective first and second RATs. Arranging of the reception opportunities from block 904 are detailed at block 908 in that the UE activates a receiver to receive a transmission using the first RAT. Arranging of the transmission opportunities from block 904 are detailed at block 910 in that there is one access node completing the steps of blocks 902 and 904 which is able to send transmissions to the user equipment simultaneously using the first and the second RATs. Arranging of the transmission opportunities from block 904 are detailed at block 912 in that there is a first access node which is able to send transmissions to the user equipment using the first RAT, and which the establishing at block 902 includes coordinating the at least one common parameter with a second access node which is able to send transmissions to the user equipment using the second RAT simultaneously with the transmissions sent from the first access node.

For any of the above described blocks of FIG. 9, block 914 gives examples of the common parameter from block 902. One example is DRX cycle, by which the first and second DRX periods of the respective first and second RATs are fully aligned. Another example it is a DRX inactivity timer. A further example is DRX on-duration time, by which the first and second DRX periods of the respective first and second RATs may in an embodiment not be fully aligned. Still for any of the above described blocks of FIG. 9, block 916 gives the embodiment in which the second DRX period is switched to receive-active only from at least one of: a transmission to the user equipment using the first radio access technology (e.g., from the access node's perspective), or reception at the user equipment using the first radio access technology (e.g., from the UE's perspective).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1-22. (canceled)

23. A method comprising:
establishing for a user equipment a first discontinuous reception period of a first radio access technology using at least one parameter that is common with a second discontinuous reception period of a second radio access technology for the user equipment; and
arranging at least one of transmission opportunities to the user equipment using the first radio access technology or reception opportunities at the user equipment using the first radio access technology, according to the established first discontinuous reception period.

24. The method according to claim 23, in which the first discontinuous reception period is within a component carrier of the first radio access technology, and the second discontinuous reception period is within a component carrier of the second radio access technology.

25. The method according to claim 23, in which arranging reception opportunities at the user equipment using the first radio access technology according to the established first discontinuous reception period comprises the user equipment activating a receiver to receive a transmission using the first radio access technology, in which the method is executed by the user equipment.

26. The method according to claim 23, executed by an access node which is able to send transmissions to the user equipment simultaneously using the first radio access technology and using the second radio access technology.

27. The method according to claim 23, executed by a first access node which is able to send transmissions to the user equipment using the first radio access technology,
in which establishing the first discontinuous reception period comprises coordinating the at least one parameter that is common with a second access node which is able to send transmissions to the user equipment using the second radio access technology simultaneously with the transmissions sent from the first access node.

28. The method according to claim 23, in which the at least one parameter that is common comprises a discontinuous reception cycle and the first and second discontinuous reception periods of the respective first and second radio access technologies are fully aligned.

29. The method according to claim 23, in which the at least one parameter that is common comprises a discontinuous reception inactivity timer.

30. A computer readable memory storing a program of instructions which when executed by at least one processor result in actions comprising:
establishing for a user equipment a first discontinuous reception period of a first radio access technology using at least one parameter that is common with a second discontinuous reception period of a second radio access technology for the user equipment; and
arranging at least one of transmission opportunities to the user equipment using the first radio access technology or reception opportunities at the user equipment using the first radio access technology, according to the established first discontinuous reception period.

31. An apparatus comprising:
at least one processor; and
at least one memory storing computer readable instructions;
in which the at least one memory with the computer readable instructions is configured with the at least one processor to cause the apparatus at least to perform:
establishing for a user equipment a first discontinuous reception period of a first radio access technology using at least one parameter that is common with a second discontinuous reception period of a second radio access technology for the user equipment; and
arranging at least one of transmission opportunities to the user equipment using the first radio access technology or reception opportunities at the user equipment using the first radio access technology, according to the established first discontinuous reception period.

32. The apparatus according to claim 31, in which the first discontinuous reception period is within a component carrier of the first radio access technology, and the second discontinuous reception period is within a component carrier of the second radio access technology.

33. The apparatus according to claim 31, in which arranging reception opportunities at the user equipment using the first radio access technology according to the established first discontinuous reception period comprises activating a receiver of the user equipment to receive a transmission using the first radio access technology, in which the apparatus comprises the user equipment.

34. The apparatus according to claim 31, in which the apparatus comprises an access node which is able to send transmissions to the user equipment simultaneously using the first radio access technology and using the second radio access technology.

35. The apparatus according to claim 31, in which the apparatus comprises a first access node which is able to send transmissions to the user equipment using the first radio access technology,
in which establishing the first discontinuous reception period comprises coordinating the at least one parameter that is common with a second access node which is able to send transmissions to the user equipment using the second radio access technology simultaneously with the transmissions sent from the first access node.

36. The apparatus according to claim 31, in which the at least one parameter that is common comprises a discontinuous reception cycle and the first and second discontinuous reception periods of the respective first and second radio access technologies are fully aligned.

37. The apparatus according to claim 31, in which the at least one parameter that is common comprises a discontinuous reception inactivity timer.
